(19) United States
(12) Patent Application Publication
(10) Pub. No.: US 2008/0269440 A1
(43) Pub. Date: Oct. 30, 2008

(54) Polymerization of Olefins

(76) Inventors: Rudolf Faust, Lexington, MA (US); Makoto Tawada, Osaka (JP)

Correspondence Address: FISH & RICHARDSON PC, P.O. BOX 1022, MINNEAPOLIS, MN, 55440-1022, US

(21) Appl. No.: 11/813,255

(22) PCT Filed: Jan. 5, 2006
(86) PCT No.: PCT/US06/00157

§ 371 Date: Mar. 25, 2008

Related U.S. Application Data
(60) Provisional application No. 60/641,544, filed on Jan. 5, 2005.

(51) Int. Cl. C08F 4/12; C08F 4/06; C08F 10/10

(52) U.S. Cl. 526/131; 526/90; 526/154; 526/348.7

(57) ABSTRACT

Compositions and methods for polymerization of olefins are disclosed that include a mixture or a reaction product of a group 4 element halide, and a group 13 element halide.

### CROSS-REFERENCE TO RELATED APPLICATION

This application claims priority from U.S. Provisional Patent Application Ser. No. 60/641,544, filed on Jan. 5, 2005, which is incorporated herein by reference in its entirety.

### TECHNICAL FIELD

This invention relates to compositions, and to methods for polymerization of olefins.

### BACKGROUND

In cationic polymerization, growing polymeric chains include an active site that has a positive charge. For example, the active site can be a carbenium ion (carbocation) or an oxonium ion.

Cationic polymerization is initiated by electrophilic agents, e.g., Brönsted acids or by cation sources such as alkyl halides, ethers or esters in conjunction with Lewis acids. Examples of Brönsted acids include hydrochloric, sulfuric, and perchloric acid, and examples of Lewis acids include AlCl₃, SnCl₄, BF₃, BF₃.(Et₂O) TiCl₄, and AgClO₄. For example, styrene can be polymerized using boron trifluoride, and tetrahydrofuran can be polymerized using methyl trifluoromethane sulfonate (methyl triflate) or triflic anhydride.

In living cationic polymerization, polymer chains grow without significant termination or chain transfer until the monomer is exhausted. Living cationic polymerization of isobutylene has been described by Faust et al. in Polymer Bulletin, 15, 317 (1986) and in J. Macromol. Sci., A29(8), 639 (1992).

### SUMMARY

The invention is based, at least in part, on the discovery that compositions that include a mixture or a reaction product of a group 4 element halide and a group 13 element halide, are useful for initiating living, cationic polymerization of olefins. Such compositions enable the user to control the rate of polymerization, e.g., effecting complete polymerization in minutes to hours, rather than seconds or days, at relatively low concentrations, e.g., an initial concentration of the group 4 element halide and the group 13 element halide of less than 0.02 mol/L. In addition, such compositions enable the preparation of high molecular weight polymers, e.g., block copolymers, and/or functionalized polymers, e.g., end-capped polymers.

For the purpose of this disclosure, initial concentrations of the group 4 element halide and the group 13 element halide are calculated as though the group 4 element halide and the group 13 element halide do not react when combined.

“Polymerization” as used herein is meant to include oligomerization.

In one aspect, the invention features methods for electrophilically polymerizing olefins. The methods include obtaining a group 4 element halide and obtaining a group 13 element halide. For example, the group 4 element can be selected from titanium, zirconium, hafnium, or mixtures of these, and the group 13 element can be selected from boron, aluminum, gallium, indium, thallium, or mixtures of these. The group 4 element halide, the group 13 element halide, optionally, an initiator such as 2-chloro-2,4,4-trimethylpentane (TMPCl) or benzyl bromide, and one or more olefins are combined to form a reaction mixture. The reaction mixture is allowed to react under conditions and for a time sufficient to enable at the one or more olefins to be polymerized.

In some embodiments, the group 4 element halide and/or the group 13 element halide are/is formed in-situ as a reaction product.

In certain embodiments, in the combining step, the group 4 element halide and the group 13 element halide are first mixed together, forming a coinitiator, and then the coinitiator is added to a solution containing at least one olefin and the initiator. In some implementations, a proton trap can be used during polymerization of the olefin, and/or the reaction can be quenched with a quenching agent, e.g., an alcohol, e.g., methanol.

In certain embodiments, the olefin is isobutylene, styrene, or a mixture of the two. Other possible olefins include, e.g., α-methyl styrene, β-methyl styrene, vinyl ethers, or mixtures of these olefins.

In some embodiments, the initiator is, e.g., 2-chloro-2,4,4-trimethylpentane (TMPCl), benzyl bromide, triphenylchloromethane (trityl chloride), or mixtures of these.

In another aspect, the invention features compositions including a mixture or a reaction product of a group 4 element halide and a group 13 element halide. For example, the group 4 element can be selected from titanium, zirconium, hafnium, or mixtures of these, and the group 13 element can be selected from boron, aluminum, gallium, indium, thallium, or mixtures of these. For example, the group 4 and group 13 elements can be a chloride, e.g., titanium tetrachloride and an aluminum chloride, e.g., an alkylaluminum chloride, respectively. The alkyl group of the alkylaluminun chloride can be, e.g., a saturated, straight, or branched hydrocarbon moiety comprising up to 15 carbon atoms.

In some embodiments, an oxidation state of the group 4 element is 4+, and an oxidation state of the group 13 element is 3+.

In some embodiments, the composition also includes an initiator, e.g., an organic halide, e.g., an alkyl halide, e.g., an alkyl chloride, e.g., 2-chloro-2,4,4-trimethylpentane (TMPCl).

In some embodiments, the composition also includes a proton trap, e.g., an amine, e.g., a hindered aromatic amine, e.g., 2,6-di-t-butylpyridine (DTBP).

In another aspect, the invention features methods of making the new compositions described herein. The methods include obtaining a group 4 element halide, and obtaining a group 13 element halide. The group 4 element can be selected from titanium, zirconium, hafnium, or mixtures of these, and the group 13 element can be selected from boron, aluminum, gallium, indium, thallium, and mixtures of these. The group 4 element halide is mixed with the group 13 element halide to form a combination. For example, the group 4 element halide and/or the group 13 element halide can be obtained by forming in-situ.

In another aspect, the invention features polyolefins having a polydispersity of less than about 2.5, e.g., less than about 1.8, 1.6, 1.4, 1.2, or less than 1.1, as measured using a universal calibration curve. In combination with a relatively low polydispersity (e.g., less than about 2.5), the polyolefin can have a number average molecular weight of between about 5,000 and about 1,000,000, also as measured using a universal calibration curve. In some embodiments, the polyolefin is polyisobutylene, or a copolymer thereof, e.g., isobutylene-styrene copolymer.

Embodiments may have one or more of the following advantages. The compositions enable a user to control the rate of reaction, allowing a user to select a desirable rate at a lower concentration of the coinitiator. Such compositions allow for moderate reaction rates, effecting complete polymerization in minutes to hours, rather than seconds or days. Since lower concentrations of coinitiator are used, purification is often simplified because, in many instances, the species remaining after quenching, e.g., titanium and aluminum oxides, do not have to be removed from the product. The compositions enable the preparation of high molecular weight polymers and copolymers, e.g., block copolymers or random copolymers, and/or functionalized polymers, e.g., allyl terminated polymers.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### DESCRIPTION OF DRAWINGS

FIG. 1 is a schematic representation of a living, cationic polymerization process, including initiation, propagation, and termination.

FIG. 2 is a schematic representation of a process for forming a block copolymer.

FIG. 3 is a schematic representation of a process for forming a random copolymer.

FIG. 4 is a schematic representation of a living, cationic polymerization process using isobutylene as the starting olefin.

FIG. 5 is a schematic representation of a process for forming a block copolymer of isobutylene and styrene.

Like reference symbols in the various drawings indicate like elements.

### DETAILED DESCRIPTION

Generally, compositions, and methods for living, cationic polymerization of olefins are disclosed. The compositions and methods include a mixture or a reaction product of a group 4 element halide, e.g., titanium tetrachloride, and a group 13 element halide, e.g., an alkyl aluminum chloride, e.g., dimethyl aluminum chloride.

### General Methodology

Generally, the new methods for cationically polymerizing olefins include obtaining a group 4 element halide and a group 13 element halide. For example, the group 4 elements are titanium, zirconium, hafnium, or mixtures of these elements, and the group 13 elements are boron, aluminum, gallium, indium, thallium, or mixtures of these elements. The group 4 element halide, the group 13 element halide, optionally, an initiator such as 2-chloro-2,4,4-trimethylpentane (TMPCl), and an olefin, or a mixture of different olefins, e.g., isobutylene and styrene, are combined to form a reaction mixture. The reaction mixture is allowed to react under conditions and for a time sufficient to polymerize the olefin or mixture of olefins. Reaction conditions will be discussed in detail below.

In some embodiments, the group 4 element halide, and the group 13 element halide are first mixed together, forming a coinitiator, and then the coinitiator is added to a solution containing the olefin or mixture of olefins and the initiator.

The methods can optionally include adding a proton trap during the polymerization of the olefin or mixture of olefins and/or quenching the reaction with a nucleophile, e.g., methanol.

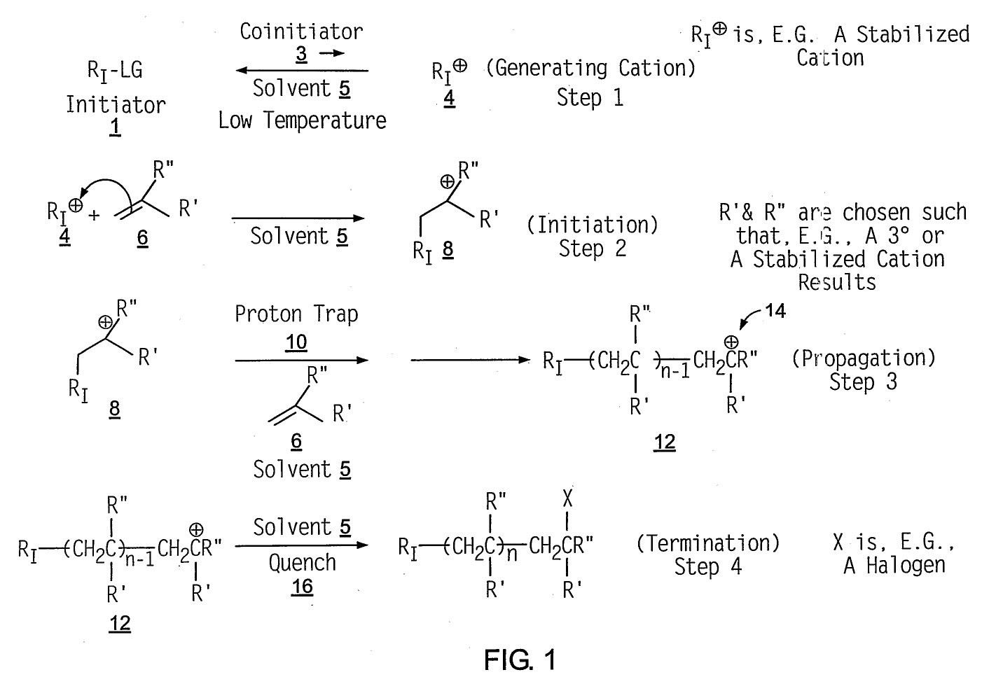

As a simplified and illustrative example, FIG. 1 shows a living, cationic polymerization process that includes four basic steps. In Step 1 (generating cation), a cationic or cationic-like species is generated. Generally, initiator 1 has a good leaving group (LG), e.g., a chloride, bromide, iodide, ester, or ether. Ionization in solvent 5 at low temperature, e.g., −80° C., utilizing a coinitiator 3, e.g., a mixture or a reaction product of dimethyl aluminum chloride and titanium tetrachloride, generates cation 4. Although Step 1 shows a “free” cation, a person of ordinary skill in the art will understand that cation 4 exists as an ion pair, e.g., a loose or tight ion pair (e.g., with Ti₂Cl₉⁻). A person of ordinary skill in the art will also understand all cations are in equilibrium with their corresponding uncharged (dormant) species, the equilibrium being predominantly towards the uncharged species. For example, the concentration of the uncharged species to the cation can be one billion-to-one. In addition, for example, the cationic species can have a lifetime of 20-40 ns, before reverting to the uncharged species.

Step 2 (initiation of polymerization) involves the attack of electrophilic cation 4 on electron-rich olefin 6, e.g., isobutylene, to generate a cationic addition product 8.

Step 3 (propagation) involves attack of the cationic addition product 8 on olefin 6. This process repeats many times, generating a living, cationic polymer 12 having a cationic active site 14. Optionally, a proton trap 10, e.g., a non-nucleophilic, hindered amine, e.g., 2,6-di-tert-butylpyridine (DTBP), is added during the polymerization to soak up any protons that may be generated during the polymerization. Generally, polymerization is carried out at reduced temperatures, e.g., −80° C. or less, e.g., −90° C., −100° C., or −110° C., or less to reduce chain transfer or termination. Generally, since the system is living, Step 3 can continue until olefin 6 is exhausted.

Step 4 shows termination, e.g., quenching, of living polymer 12 with a quenching agent 16, e.g., methanol. Quenching agent 16 can be, e.g., water, an alcohol, an amine, or a compound including a sulfhydryl group. Due to the equilibrium that exists between the dormant species and an active cationic species, often the polymer is terminated with a halogen upon quenching. If the reaction is quenched with a species that does not react with the coinitiator, e.g., trimethylallylsilane, a functionalized polymer can be obtained.

Although FIG. 1 illustrates a living, cationic polymerization as four isolated steps, a person of ordinary skill in the art will understand that FIG. 1 is an abstraction for illustrative purposes only, as it does not show all the mechanistic details. For example, counter-ions are not shown, nor are equilibria that exist between dormant species and active cationic species. Mechanistic details regarding cationic polymerization have been discussed by Faust et al. in Macromolecules, 36, 8282 (2003) and Macromolecules, 33, 8225 (2000).

### Coinitiators

Coinitiators include a mixture or a reaction product of a group 4 element halide, and a group 13 element halide. The group 4 elements include titanium, zirconium, hafnium, or mixtures of these elements, and the group 13 elements include boron, aluminum, gallium, indium, thallium, or mixtures of these elements.

Without wishing to be bound by any particular theory, it is believed that when the group 4 element halide and the group 13 element halide are combined, an intermediate reaction product is produced, e.g., an aluminum-titanium adduct, which enables greater control over the polymerization of the olefin. Generally, only a low concentration of the coinitiator is needed in the reaction mixture, e.g., an initial concentration of the group 4 element halide and the group 13 element halide of less than 0.06 mol/L, e.g., 0.040, 0.030, 0.020, 0.004, or 0.001 mol/L.

Examples of suitable group 4 element halides include halides that are in the 3+ or 4+ oxidation state. Specific examples of suitable group 4 element halides include bis(cyclopentadienyl)titanium (IV), chlorotriisopropyltitanium (IV), cyclopentadienyl titanium(IV) trichloride, titanium (III) chloride, titanium (IV) chloride (titanium tetrachloride), titanium (III) fluoride, titanium (IV) fluoride, titanium (IV) iodide, bis(butylcyclopentadienyl)zirconium(IV) dichloride, bis(cyclopentadienyl)zirconium(IV) dichloride, zirconium(IV) bromide, zirconium(IV) chloride, bis(pentamethylcyclopentadienyl)hafnium dichloride, hafnium(IV) bromide, hafnium(IV) chloride, hafnium(IV) fluoride, hafnium(IV) iodide, cerium(III) chloride, cerium(III) bromide, and cerium (III) iodide.

Examples of suitable group 13 element halides include halides that are in the 1+, 2+, or 3+ oxidation state. Specific examples of suitable group 13 element halides include chlorodicyclohexylborane, dimesitylboron fluoride, aluminum chloride, diethylaluminum chloride, diisobutylaluminum chloride, dimethylaluminum chloride, gallium(III) bromide, gallium(II) chloride, gallium(III) chloride, indium(I) bromide, indium(III) bromide, indium(I) chloride, indium(II) chloride, indium(III) chloride, indium(I) iodide, indium(III) iodide, thallium(I) chloride, thallium(I) fluoride, thallium(III) fluoride, thallium(I) iodide, holmium(III) chloride, holmium(III) bromide, and holmium(III) iodide.

In some embodiments, each group 4 element halide includes a chloride, and each group 13 element halide includes a chloride.

In some embodiments, the group 4 element halide includes titanium tetrachloride, and the group 13 element halide includes an aluminum chloride. In specific implementations, the aluminum chloride can include an alkylaluminum chloride, e.g., a dialkylaluminum chloride, e.g., dimethylaluminum chloride. In some embodiments, each alkyl group of the dialkylaluminum chloride is the same, and/or each alkyl group of the alkylaluminun chloride includes a saturated, straight, or branched hydrocarbon moiety including up to 15 carbon atoms, e.g., methyl, propyl, isopropyl, isobutyl, neopentyl, n-octyl, or n-undecyl.

In some specific embodiments, the group 13 element halide is represented by formula (I)

RₓAlZ₍₃₋ₓ₎, (I)

where R is a saturated, straight, or branched hydrocarbon moiety including up to 15 carbon atoms, e.g., methyl, ethyl, propyl, isopropyl, n-hexyl, or n-dodecyl, X is 0, 1, or 2, and Z is F, Cl or Br.

In some embodiments, a mole ratio of the group 4 element to the group 13 element is from about 0.25:1.00 to about 1.00:0.25, e.g., from about 0.50:1.00 to about 1.00:1.00. In specific implementations, only a small amount of the group 4 element to the group 13 element is needed to achieve rate control over the polymerization, e.g., 0.02:1.00. In other specific implementations, only a small amount of the group 13 element to the group 4 element is needed to achieve rate control over the polymerization, e.g., 0.02:1.00.

In specific embodiments, the coinitiator solution is prepared by mixing Me₂AlCl as a 1M solution in hexanes with neat titanium tetrachloride (TiCl₄). The resulting coinitiator solution in hexane can be optionally cut by adding another solvent, e.g., methyl chloride.

### Initiators

Generally, initiators have a readily ionizable leaving group, e.g., a halogen, e.g., chloride or bromide, and an R group of the initiator forms a relatively stable cation, e.g., a tertiary or a resonance stabilized cation, e.g., a benzylic cation or a cation having an immediately adjacent heteroatom having unpaired electrons, e.g., an oxygen atom. Having a relatively stable cation ensures that the cation survives long enough to initiate polymerization. Suitable initiators include, e.g., 2-chloro-2,4,4-trimethyl-pentane (TMPCl), cumyl chloride, cumyl acetate, cumyl methyl ether, and benzyl bromide. Multifunctional initiators such as dicumyl chloride can also be used.

Generally, a low concentration of the initiator is desirable, e.g., an initial concentration of less than 0.06 mol/L, e.g., 0.040, 0.030, 0.020, 0.004, 0.001 mol/L.

### Proton Traps

When used, proton traps soak up any protons that may be generated during polymerization and can enable the generation of polymers having especially high molecular weights, e.g., absolute molecular weights of 100,000 or more, e.g., 200,000, 250,000, 350,000 or more, e.g., 500,000. Ideally, the proton does not participate in the polymerization. It is desirable that the proton trap be a relatively non-nucleophilic, hindered moiety, thereby reducing quenching and elimination reactions with the proton trap. For example, the proton trap can be a non-nucleophilic, hindered amine, e.g., 2,6-di-tert-butylpyridine (DTBP), or N,N-di-isopropyl-3-pentyl amine. Non-hindered Lewis bases, e.g., pyridine, 2,6-dimethylpyridine, can also be utilized.

Generally, a low concentration of the proton trap is desirable, e.g., an initial concentration of less than 0.06 mol/L, e.g., less than 0.040 mol/L, less than 0.030 mol/L, less than 0.020 mol/L, less than 0.004, or less than 0.001 mol/L.

### Olefins

Generally, olefins or mixtures of olefin that generate a tertiary cation, a benzylic cation or a cation having an immediately adjacent heteroatom having unpaired electrons, e.g., an oxygen atom, upon addition of an electrophile into the double bond are suitable.

Examples of olefins that generate a tertiary cation upon addition of an electrophile into the double bond include isobutylene, and other 1,1-disubstituted vinyl compounds, e.g., 2-ethyl-pent-1-ene and 2-ethyl-4-methyl-pent-1-ene.

Examples of olefins that generate a benzylic cation upon addition of an electrophile into the double bond include styrene, and alkyl, alkoxy, aryl, or halogen substituted styrenes in which the alkyl or aryl group includes up to 10 carbon atoms, e.g., 4-methylstyrene, 4-methoxystyrene, 4-chlorostyrene, and α-alkyl styrenes, e.g., 4-chloro-α-methylstyrene, and 4-methyl-α-methylstyrene.

Examples of olefins that generate cations having an immediately, adjacent heteroatom having unpaired electrons, e.g., an oxygen atom, upon addition of an electrophile into the double bond include vinyl ethers, e.g., ethylvinylether, isobutylvinylether, octadecylvinylether, and propylvinylether. Cations of such ethers are stabilized by oxygen lone pair donation.

Generally, an initial concentration of the olefin is around 0.5 mol/L or greater, e.g., 1.0, 2.0, 3.0, 4.0 mol/L or greater, e.g., 10 mol/L.

### Reaction Conditions to Maintain a Living System

Generally, reaction conditions are chosen to maintain a living system. In some embodiments, it is also desirable to maintain a homogenous, single phase system, e.g., when one wants to minimize the polydispersity of the resulting polymer obtained. Homogenizing can be accomplished by choosing the appropriate solvent and by applying a force to the solution, e.g., stirring with a stir bar, shaking, vortexing, or applying ultrasound to the solution. Generally, oxygen and water are avoided, e.g., by employing standard Schlenk line or glove-box techniques, to prevent premature termination.

Generally, to maintain a living system, the reaction mixture is maintained at a temperature of less than −50° C., e.g., −60° C., −70° C., −80° C., or less, e.g., −10° C.

### Solvents

Generally solvents used in the living, cationic polymerizations do not participate or react with any reagent in the polymerization system, e.g., they do not react with the electrophilic coinitiators. Suitable solvents include hydrocarbons, halogenated solvents, nitro compounds, and mixtures of these solvents. Examples of halogenated solvents include methylene chloride, methyl chloride, ethylene dichloride, and n-butyl chloride. Examples of nitro compounds include nitromethane and nitrobenzene. Examples of hydrocarbons include aliphatic hydrocarbons, e.g., butane, hexane, pentane, cyclopentane, cyclohexane, and methylcyclohexane, and aromatic hydrocarbons, e.g., toluene.

The rate of polymerization can be controlled, e.g., by controlling the polarity of the solvent. For example, rates tend to be slower in less polar solvents, e.g., hydrocarbons and carbon tetrachloride, and faster in more polar solvents, e.g., methyl chloride and nitromethane. It is often advantageous to use a mixed solvent system, e.g., hexane and methyl chloride, to adjust polarity, and to adjust the solvating properties of the solvent towards the polymer. Rate can also be controlled by changing the concentration of the initiator or coinitiator, or by changing the temperature.

### Block Copolymers

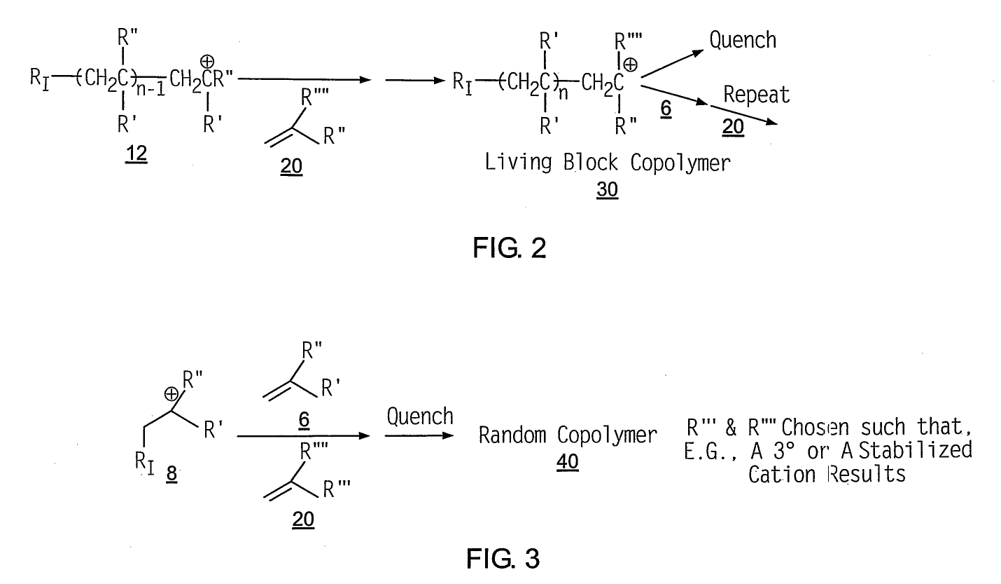

As shown in FIG. 1, the reaction mixture can initially include, e.g., a single olefin, e.g., isobutylene, and the method can further include allowing the reaction mixture to become depleted of the single olefin, producing a living, cationic polymer 12 that includes a single block formed of only a single repeating unit. As shown in FIG. 2, a second olefin 20, e.g., styrene, can be added such that living, cationic polymer 12 initiates polymerization of second olefin 20. The reaction is allowed to occur under conditions and for sufficient time to polymerize second olefin 20, producing a second block. The resulting living, cationic block copolymer 30 can be quenched, and the resulting block copolymer isolated.

Instead of quenching the living, cationic block copolymer 30, additional monomer 6 can be added, and the polymer chains allowed to grow until the system becomes depleted of monomer 6. After which, more olefin 20 can be added to grow the polymer chains even longer. This process can be continued many times to produce multi-block, block copolymers of desired composition and molecular weight.

A third, forth, or even fifth monomer can be used to produce tri-, tetra-, and penta-block copolymers, respectively.

Although FIG. 2 shows a synthetic scheme that makes a block copolymer using a monofunctional initiator, multifunctional initiators, e.g., dicumyl chloride, can also be used. In this procedure, the difunctional initiator is used to make a difunctional living polymer, and then the selected olefins are added to make the selected block copolymer.

### Random Copolymers

As shown in FIG. 3, the reaction mixture can initially include two olefins 6 and 20. If the rate of polymerization of both 6 and 20 are comparable, a random copolymer 40 of 6 and 12 will be obtained after quenching.

While FIG. 3 shows only two olefins, more than two can be used. For example, 3, 4, 5, 6, or more, e.g., 8, different olefins can be used.

### Homopolymers of Isobutylene

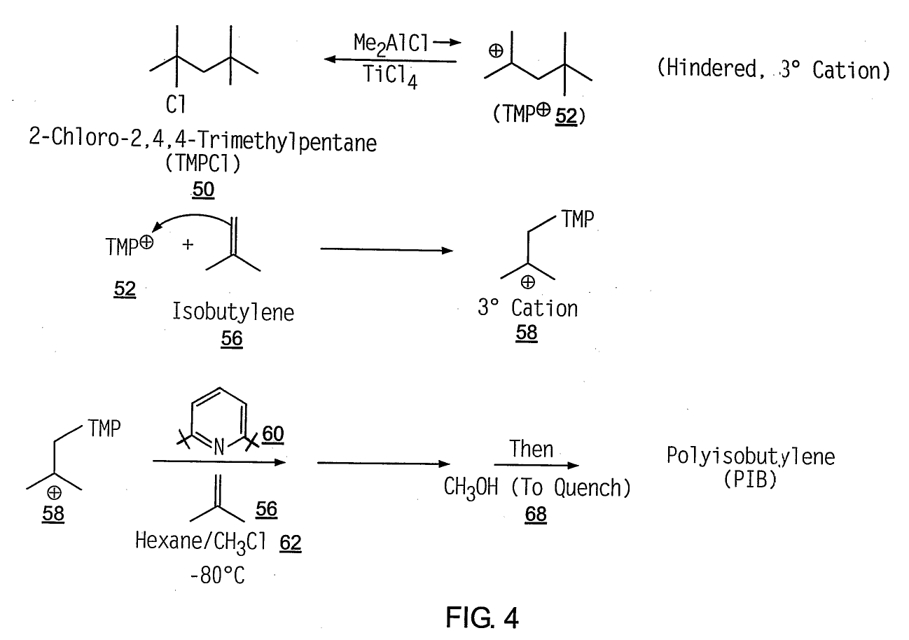

As shown in FIG. 4, isobutylene 56 can be polymerized at −80° C. in hexane/methyl chloride 62 as the solvent using 2-chloro-2,4,4-trimethylpentane (TMPCl) 50 as the initiator, a mixture of dimethyl aluminum chloride and titanium tetrachloride as the coinitiator, and 2,6-di-tert-butylpyridine (DTBP) 60 as the proton trap.

TMPCl 50 reacts with the coinitiator, producing a tertiary, hindered carbocation, TMP⁺ 52. TMP⁺ 52 is useful as an electrophilic cation because it is a tertiary cation, and is thus less prone to rearrangement than, e.g., a secondary cation.

Attack of electrophilic cation 52 on electron rich olefin isobutylene 56, generates cationic addition product 58. Regio-specificity of addition is directed to produce the tertiary cation 58 shown.

Attack of the cationic addition product 58 on isobutylene 56 grows the cation by one unit. This process repeats itself many times, generating a living, cationic isobutylene polymer. 2,6-di-tert-butylpyridine 60 acts a proton sponge to soak up any protons that may be generated during the polymerization.

In this particular system, the living polymer is quenched with methanol 68.

### Block Copolymers of Isobutylene and Styrene

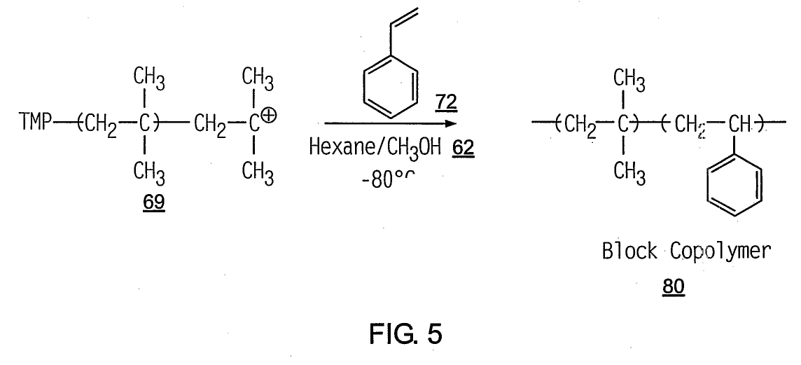

As shown in FIG. 4, the reaction mixture can initially include only isobutylene. The reaction mixture can be allowed to become depleted of isobutylene, producing a living, cationic polymer 69 that includes a single block formed of isobutylene-derived repeat units. At this point, styrene 72 (FIG. 5) can be added such that living, cationic polymer 69 initiates polymerization of the styrene. The reaction is allowed to occur under conditions and for sufficient time to polymerize the styrene, producing a second block. The resulting living, cationic block copolymer is quenched with methanol, producing a isobutylene-styrene block copolymer 80.

Instead of quenching the living, cationic block copolymer, additional monomer, e.g., styrene or isobutylene, can be added, and the polymer chains allowed to grow more. This process can be continued many times to produce multi-block, block copolymers.

### Molecular Weight of the Polymers

Generally, since the systems described herein are living, there is no theoretical limit to the molecular weight that can be obtained, provided that chain termination is minimized by keeping the temperature of the reaction mixture sufficiently low, and impurities in the system sufficiently negligible. However, as the average molecular weight of the living polymer increases, solubility of the polymer can be reduced, slowing the rate of polymerization. Maintaining a sufficiently solubilized polymer and a sufficiently low solution viscosity enables production of particularly high molecular weight polymers having generally low polydispersities, e.g., less than 2.2.

The methods described can provide a polymerized olefin having an absolute number average or weight average molecular weight from about 5,000 to about 1,000,000, e.g., 10,000, 25,000, 100,000, 250,000 or more, e.g., 750,000. In addition, the methods can generally provide a polydispersity of less than about 2.5, e.g., 1.8, 1.6, 1.4, 1.2 or less, e.g., 1.1.

### Applications

The polymers described can be used as resin modifiers, e.g., to improve shock, weather, and/or heat resistance of various other plastics, e.g., polyolefins. For example, the polymers described are useful in manufacturing tires, roofing membranes, vapor and/or gas barriers, stoppers, hoses, and sealants, e.g., caulks.

### EXAMPLES

The invention is further described in the following examples, which do not limit the scope of the invention described in the claims.

### Materials

Titanium tetrachloride (TiCl₄, Aldrich, 99.9%), dimethylaluminum chloride (Me₂AlCl, Aldrich, 1 M solution in hexanes), 2,6-di-tert-butylpyridine (DTBP, Aldrich, 97%) were used as received. 2-Chloro-2,4,4-trimethylpentane (TMPCl) was prepared according to the literature (Fodor, Zs.; Faust, R., J. Macromol. Sci., Pure App. Chem., 1996, A33, 305). Methyl chloride (MeCl), isobutylene (IB, 2-methylpropene, Aldrich, 99%), hexane (Hex), styrene and methanol were been purified as described previously (Gyor, M.; Wang, H. C.; Faust, R., J. Macromol. Sci., Pure Appl. Chem., 1992, A29, 639).

### Polymerization

Polymerization was carried out under a dry nitrogen atmosphere in an Mbraun 150M glove box (Innovative Technology Inc., Newburyport, Mass.). Culture tubes (75 mL) were used as polymerization reaction vessels. The polymerization mixture was quenched with excess chilled methanol. Polyisobutylene (PIB) was recovered and purified two times by precipitation from Hex/methanol. Monomer conversion was determined gravimetrically.

### Characterization

Molecular weights were measured at room temperature using a Waters HPLC system equipped with a Model 510 HPLC pump, a Model 250 dual refractometer/viscometer detector (Viscotek), a Model 486 UV/Vis detector, a Model 712 sample processor, and five ultra-Styragel® GPC columns connected in the following series: 500, 10³, 10⁴, 10⁵, and 100 Å. Tetrahydrofuran was used as eluent at a flow rate of 1.0 mL/min. Molecular weight and molecular weight distribution were determined by using the universal calibration curve (Viscotek TriSEC™ GPC software).

### Example 1

### Polymerization of Isobutylene (IB) using 2-Chloro-2,4,4-trimethylpentane (TMPCl) in the Presence of TiCl₄ ad Me₂AlCl

The initiator solution was prepared by dissolving 0.0743 g of 2-chloro-2,4,4-trimethylpentane (TMPCl) in 4.9 mL of hexane at room temperature in a 50 mL culture tube, and then cooling the solution to −80° C. The proton trap solution was prepared by dissolving 0.1339 g of 2,6-di-t-butylpyridine (DTBP) in 3.8 ml of hexane at room temperature. The proton trap solution was then placed in a 50 mL culture tube, and cooled to −80° C. The coinitiator solution was prepared by charging a 50 mL culture tube with 4.05 mL of a 1 M solution of Me₂AlCl in hexanes (volume measured at room temperature), and then cooling to −80° C. To this Me₂AlCl solution was added 0.44 mL of TiCl₄ (volume measured at room temperature), followed by the addition of 22.5 mL of methyl chloride (volume measured at −80° C.), while maintaining the mixture at −80° C.

For the polymerization, a 50 mL culture tube was charged with 9.60 mL of hexane (volume measured at room temperature) and then the hexane was cooled to −80° C. To the cooled hexane was added 7.47 mL of methyl chloride (volume was measured at −80° C.). To this hexane/methyl chloride solution was added 3.90 mL of isobutylene (volume measured at −80° C.). To this cooled isobutylene solution, 0.5 mL of the initiator solution and 0.5 mL of the proton trap solution (both volumes measured at −80° C.) were added. Polymerization was initiated by adding 3.0 mL of the coinitiator mixture (volume measured at −80° C.) to the solution containing the isobutylene. Total volume in the polymerization vessel was 25 mL (measured at −80° C.).

At the onset of polymerization, the concentration of each component was (based on the total solution):

Initiator: TMPCl, 2.0×10⁻³ M

Proton Trap: DTBP, 3.5×10⁻³ M

Monomer: IB, 2.0 M

Coinitiator: TiCl₄, 1.8×10⁻² M; Me₂AlCl, 1.8×10⁻² M.

After reaction for three minutes at −80° C., the reaction was quenched by adding excess methanol at −80° C. The resulting solution was poured into a flask containing methanol, precipitating the polyisobutylene as a white material. The polyisobutylene precipitate was dissolved in hexane, and then poured into methanol to re-precipitate. This precipitation process was repeated twice more to purify the polymer. Conversion was 89%, M_{N} was 41,300 and M_{W}/M_{N} (polydispersity) was 1.31.

### Example 2

### Polymerization of Isobutylene (IB) using 2-Chloro-2,4,4-trimethylpentane (TMPCl) in the Presence of TiCl₄ and Me₂AlCl

The initiator, coinitiator, monomer and proton trap solutions were prepared using the same procedure outlined in Example 1.

At the onset of polymerization, the concentration of each component was (based on the total solution):

Initiator: TMPCl, 2.0×10⁻³ M

Proton Trap: DTBP, 3.5×10⁻³ M

Monomer: IB, 2.0 M

Coinitiator: TiCl₄, 9.5×10⁻³ M; Me₂AlCl, 9.5×10⁻³ M.

After reaction for thirty minutes at −80° C., the reaction was quenched with methanol at −80° C., and then the polymer purified according to the procedure outlined in Example 1. Conversion was 92%, M_{N} was 53,400 and M_{W}/M_{N} (polydispersity) was 1.09.

### Example 3

### Polymerization of Isobutylene (IB) using 2-Chloro-2,4,4-trimethylpentane (TMPCl) in the Presence of TiCl₄ and Me₂AlCl

The initiator, coinitiator, monomer and proton trap solutions were prepared using the same procedure outlined in Example 1.

At the onset of polymerization, the concentration of each component was (based on the total solution):

Initiator: TMPCl, 2.0×10⁻³ M

Proton Trap: DTBP, 3.5×10⁻³ M

Monomer: IB, 2.0 M

Coinitiator: TiCl₄, 4.8×10⁻³ M; Me₂AlCl, 4.8×10⁻³ M.

After reaction for thirty minutes at −80° C., the reaction was quenched with methanol at −80° C., and then the polymer was purified according to the procedure outlined in Example 1. Conversion was 83%, M_{N} was 46,400 and M_{W}/M_{N} (Polydispersity) was 1.08.

### Example 4

### Polymerization of Isobutylene (IB) using 2-Chloro-2,4,4-trimethylpentane (TMPCl) in the Presence of TiCl₄ and Me₂AlCl

The initiator, coinitiator, monomer and proton trap solutions were prepared using the same procedure outlined in Example 1.

At the onset of polymerization, the concentration of each component was (based on the total solution):

Initiator: TMPCl, 2.0×10⁻³ M

Proton Trap: DTBP, 3.5×10⁻³ M

Monomer: IB, 2.0 M

Coinitiator: TiCl₄, 3.0×10⁻³ M; Me₂AlCl, 3.0×10⁻³ M.

After reaction for ninety minutes at −80° C., the reaction was quenched with methanol at −80° C., and then the polymer was purified according to the procedure outlined in Example 1. Conversion was 21%.

### Example 5

### Copolymerization of Isobutylene (IB) and Styrene Using 2-Chloro-2,4,4-trimethylpentane (TMPCl) in the Presence of TiCl₄ and Me₂AlCl

The initiator solution was prepared by dissolving 0.1115 g of 2-chloro-2,4,4-trimethylpentane (TMPCl) in 7.4 mL of hexane at room temperature in a 50 mL culture tube, and then cooling the solution to −80° C. The proton trap solution was prepared by dissolving 0.2511 g of 2,6-di-t-butylpyridine (DTBP) in 7.2 ml of hexane at room temperature. The proton trap solution was then placed in a 50 mL culture tube, and cooled to −80° C. The coinitiator solution was prepared by charging a 50 mL culture tube with 1.90 mL of a 1 M solution of Me₂AlCl in hexanes (volume measured at room temperature), and then cooling to −80° C. To this Me₂AlCl solution was added 0.208 mL of TiCl₄ (volume measured at room temperature), followed by the addition of 21.9 mL of methyl chloride (volume measured at −80° C.), while maintaining the mixture at −80° C.

For the polymerization, a 50 mL culture tube was charged with 13.7 mL of hexane (volume measured at room temperature) and then the hexane was cooled to −80° C. To the cooled hexane was added 7.24 mL of methyl chloride (volume was measured at −80° C.). To this hexane/methyl chloride solution was added 3.90 mL of isobutylene (volume measured at −80° C.). To this cooled isobutylene solution, 0.5 mL of the initiator solution and 0.5 mL of the proton trap solution (both volumes measured at −80° C.) were added. Polymerization was initiated by adding 3.00 mL of the coinitiator mixture (volume measured at −80° C.) to the solution containing the isobutylene. The isobutylene was allowed to polymerize for sixty minutes, and then styrene was added to the living polyisobutylene solution. To make the styrene solution, a 50 mL culture tube was charged with 7.97 mL styrene and 25.93 mL hexane (both volumes measured at room temperature), and then the mixture was cooled to −80° C. To this cooled styrene/hexane solution was added 12.80 mL methyl chloride (measured at −80° C.). Styrene polymerization was started by adding 5.0 mL of the styrene/hexane/methyl chloride solution to the living polyisobutylene solution from above.

After reaction for 16 minutes at −80° C., the reaction was quenched with methanol at −80° C., and then the copolymer was purified according to the procedure outlined in Example 1. Conversion for IB was 95%, and conversion for styrene was 36%.

### Other Embodiments

A number of embodiments of the invention have been described. Nevertheless, it will be understood that various modifications may be made without departing from the spirit and scope of the invention. Accordingly, other embodiments are within the scope of the following claims.

1. A method for electrophilically polymerizing olefins, the method comprising:
obtaining a group 4 element halide;
obtaining a group 13 element halide;
combining the group 4 element halide, the group the 13 element halide, optionally, an initiator, and one or more olefins to form a reaction mixture; and
allowing the reaction mixture to react under conditions and for a time sufficient to enable the one or more olefins to be polymerized.

2. The method of claim 1, wherein the group 4 element is selected from the group consisting of titanium, zirconium, hafnium, and mixtures thereof.

3. The method of claim 1, wherein the group 13 element is selected from the group consisting of boron, aluminium, gallium, indium, thallium, and mixtures thereof.

4. The method of claim 1, wherein in the combining step, the group 4 element halide and the group 13 element halide are the first mixed together, forming a coinitiator, and then the coinitiator is added to a solution containing the one or more olefins and the initiator.

5. The method of claim 1, further comprising adding a proton trap during the polymerization of the one or more olefins.

6. The method of claim 1, further comprising quenching the reaction with a nucleophile.

7. The method of claim 1, wherein the one or more olefins comprises isobutylene.

8. The method of claim 1, wherein conditions include maintaining the reaction mixture at a temperature less than −50° C.

9. The method of claim 1, wherein conditions include homogenizing the reaction mixture.

10. The method of claim 1, wherein the reaction mixture comprises a single olefin, and the method further comprises allowing the reaction mixture to become depleted of the single olefin, adding a second olefin, and then allowing reaction to occur under conditions and for a time sufficient to polymerize the second olefin, producing a block copolymer.

11. The method of claim 1, wherein the polymer has a number average molecular weight from about 10,000 to about 1,000,000, as measured by a universal calibration curve.

12. The method of claim 1, wherein the polymer has a polydispersity of less than about 2.5, as measured by a universal calibration curve.

13. The method of claim 1, wherein the initiator is selected from the group consisting of 2-chloro-2,4,4-trimethylpentane (TMPCl), benzyl bromide, triphenylchloromethane (trityl chloride), and mixtures thereof.

14. A composition a mixture or a reaction product of:
a group 4 element halide; and
a group 13 element halide.

15. The composition of claim 14, wherein the group 4 element is selected from the group consisting of titanium, zirconium, hafnium, and mixtures thereof, and wherein the group 13 element is selected from the group consisting of boron, aluminum, gallium, indium, thallium, and mixtures thereof.

16. The composition of claim 14, wherein the group 4 element halide comprises a chloride.

17. The composition of claim 14, wherein the group 13 element halide comprises a chloride.

18. The composition of claim 14, wherein an oxidation state of the group 4 element is 4+.

19. The composition of claim 14, wherein an oxidation state of the group 13 element is 3+.

20. The composition of claim 14, wherein a mole ratio of the group 4 element to the group 13 element is from about 0.02:1.00 to about 1.00:0.02.

21. The composition of claim 14, wherein the composition further comprises an initiator.

22. The composition of 14, wherein the composition further comprises a proton trap.

23. A polyolefin comprising polyisobutylene and having a polydispersity of less than 2.5, as measured using a universal calibration curve.

24. The polyolefin of claim 23, wherein the polydispersity is less than 1.8.

25. The polyolefin of claim 24, wherein the polydispersity is less than 1.2.

26. The polyolefin of claim 23 having a number average molecular weight of between about 5,000 and about 1,000,000, as measured using a universal calibration curve.

27. The polyolefin of claim 23, wherein the polyolefin comprises a polyisobutylene homopolymer.
